(19) United States
(12) Patent Application Publication
(10) Pub. No.: US 2026/0017141 A1
(43) Pub. Date: Jan. 15, 2026

(54) REDUNDANT ARRAY OF INDEPENDENT NOT-AND (RAIN) BLOCK RETIREMENT HANDLING

(71) Applicant: Micron Technology, Inc., Boise, ID (US)

(72) Inventors: Varaprasad Ramoju, Rajamahendravaram (IN); Daniel Danching Zhang, Milpitas, CA (US); Tingjun Xie, Milpitas, CA (US); Juane Li, Milpitas, CA (US); Aaron Lee, Sunnyvale, CA (US); Zhenlei Shen, Milpitas, CA (US)

(21) Appl. No.: 19/250,188

(22) Filed: Jun. 26, 2025

Related U.S. Application Data
(60) Provisional application No. 63/671,531, filed on Jul. 15, 2024.

(51) Int. Cl. G06F 11/10; G06F 11/20

(52) U.S. Cl. CPC G06F 11/108; G06F 11/1016; G06F 11/1048; G06F 11/2094

(57) ABSTRACT

Methods, systems, and devices for redundant array of independent not-AND (RAIN) block retirement handling are described. A memory system may implement techniques to avoid the preemptive retirement of a block of a memory device. In some examples, the memory system may count a quantity of bit errors for each block while performing a recovery procedure, such as a RAIN procedure. The memory system may determine that the quantity of bit errors satisfies a threshold for multiple blocks, which indicate that the error that triggered the recovery procedure may have been caused by intrinsic stress at the memory system, and the memory system may refrain from retiring the block. In some examples, the memory system may compare the corrected data with raw data read using stored read settings from a failed read operation, and the memory system may determine whether to retire the block based on the comparison.

### CROSS REFERENCE

The present Application for Patent claims priority to U.S. Patent Application No. 63/671,531 by Ramoju et al., entitled “REDUNDANT ARRAY OF INDEPENDENT NOT-AND (RAIN) BLOCK RETIREMENT HANDLING,” filed Jul. 15, 2024, which is assigned to the assignee hereof, and which is expressly incorporated by reference in its entirety herein.

### TECHNICAL FIELD

The following relates to one or more systems for memory, including redundant array of independent not-AND (RAIN) block retirement handling.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports handling of block retirement in accordance with examples as disclosed herein.

FIG. 2 shows an example of a flowchart that supports handling of block retirement in accordance with examples as disclosed herein.

FIG. 3 shows an example of a flowchart that supports handling of block retirement in accordance with examples as disclosed herein.

FIG. 4 shows a block diagram of a memory system that supports handling of block retirement in accordance with examples as disclosed herein.

FIGS. 5 and 6 show flowcharts illustrating a method or methods that support handling of block retirement in accordance with examples as disclosed herein.

### DETAILED DESCRIPTION

Some memory systems may perform scans for errors, such as uncorrectable errors, to protect against data loss. In some cases, memory systems may deploy recovery procedures in response to detecting one or more uncorrectable errors at a block of a memory device, such as a redundant array of independent not-AND (RAIN) procedure. In some examples, the memory systems may retire blocks associated with errors that trigger the recovery procedures, which may avoid the use of a faulty (e.g., defective) block of a memory device. In some cases, however, a false trigger of the recovery procedure may cause a block to be preemptively retired. Additionally, or alternatively, as correction procedures (e.g., algorithms) for blocks improve, faults in the blocks associated with triggering the recovery procedure may be corrected during operation of the memory system.

In accordance with examples as described herein, memory systems may implement techniques to avoid the preemptive retirement of a block of a memory device. In some examples, the memory system may count a quantity of bit errors for each block while performing a recovery procedure, such as a RAIN procedure. The memory system may determine that the quantity of bit errors is relatively high (e.g., satisfies a threshold) for multiple blocks, different from the block associated with an error that triggered the recovery procedure. The high quantity of errors across multiple blocks may indicate that the error that triggered the recovery procedure may have been caused by conditions of the memory system (e.g., intrinsic stress, temperature conditions) rather than a faulty block, and the memory system may refrain from retiring the block.

In other examples, the memory system may store read setting for a failed read operation that triggers a recovery procedure, such as RAIN. If the recovery procedure succeeds in recovering the data, the memory system may perform a read operation of the raw data using the stored read settings for the failed read operation. The memory system may count a quantity of bit errors for reading the raw data using the stored read setting relative to the corrected data. In some examples, the quantity of bit errors being relatively low (e.g., not satisfying a threshold) may indicate that the error may have been due to conditions of the memory system (e.g., intrinsic stress, temperature conditions), and the memory system may refrain from retiring the block. Accordingly, the memory system may avoid preemptively retiring blocks, which may extend the storage capacity over the lifespan of the memory system.

In addition to applicability in memory systems as described herein, techniques for handling of block retirement during recovery procedures may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing the preemptive retirement of memory blocks if a corresponding error was caused by conditions of the memory system as a whole, which may extend the life of the memory system and maintain a larger capacity throughout the life of the memory system, thereby reducing electronic waste, among other benefits.

Features of the disclosure are illustrated and described in the context of systems, devices, and circuits. Features of the disclosure are further illustrated and described in the context of flowcharts and block diagrams.

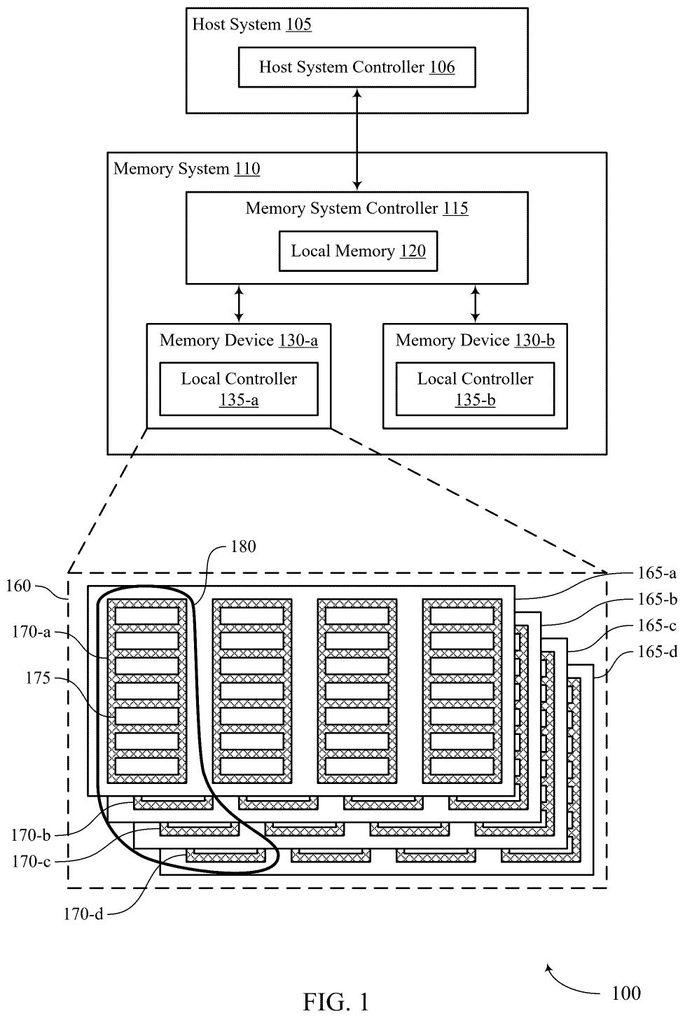

FIG. 1 shows an example of a system 100 that supports handling of block retirement in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

The memory system 110 may perform scans for errors (e.g., via the memory system controller 115, local controllers 135, or both), such as uncorrectable errors, to protect against data loss. In some cases, the memory systems 110 may deploy recovery procedures in response to detecting one or more uncorrectable errors at a block 170 of a memory device 130, such as a RAIN procedure. In some examples, the memory systems may retire blocks 170 associated with errors that trigger the recovery procedures, which may avoid the use of a faulty (e.g., defective) block 170 of a memory device 130. In some cases, however, a false trigger of the recovery procedure may cause a block 170 to be preemptively retired. Additionally, or alternatively, as correction procedures (e.g., algorithms) for blocks 170 improve, faults in the blocks 170 associated with triggering the recovery procedure may, in some cases, be corrected during operation of the memory system 110.

In accordance with examples as described herein, the memory system 110 may implement techniques to avoid the preemptive retirement of a block 170 of a memory device 130. In some examples, the memory system 110 may count a quantity of bit errors for each block 170 while performing a recovery procedure, such as a RAIN procedure. The memory system may determine that the quantity of bit errors is relatively high (e.g., satisfies a threshold) for multiple blocks 170, different from the block 170 associated with an error that triggered the recovery procedure. The high quantity of errors across multiple blocks 170 may indicate that the error that triggered the recovery procedure may have been caused by conditions of the memory system 110 (e.g., intrinsic stress, temperature conditions, power inconsistencies, or other conditions that may temporarily results in errors) rather than a faulty block 170, and the memory system 110 may refrain from retiring the block 170.

In other examples, the memory system 110 may store read setting for a failed read operation that triggers a recovery procedure, such as a RAIN procedure. If the recovery procedure succeeds in recovering the data, the memory system 110 may perform a read operation of the raw data using the stored read settings for the failed read operation. The memory system 110 may count a quantity of bit errors for reading the raw data using the stored read setting relative to the corrected data. In some examples, the quantity of bit errors being relatively low (e.g., not satisfying a threshold) may indicate that the error may have been due to the conditions of the memory system, and the memory system 110 may refrain from retiring the block 170. Accordingly, the memory system 110 may avoid preemptively retiring blocks 170, which may extend the storage capacity over the lifespan of the memory system 110.

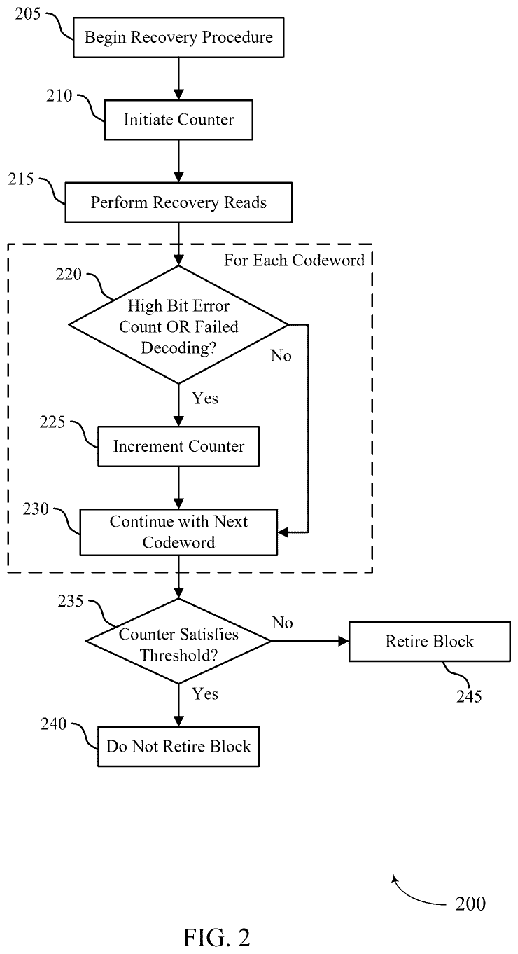

FIG. 2 shows an example of a flowchart 200 that supports handling of block retirement in accordance with examples as disclosed herein. Operations of the flowchart 200 may be implemented by a memory system 110 (e.g., a memory system controller 115, one or more local controllers 135, or a combination thereof). In some cases, the flowchart 200 may include additional operations (not shown), or operations may be omitted, modified, or performed in a different order in accordance with the described techniques.

At 205, a memory system 110 may begin a recovery procedure. For example, the memory system may initiate a RAIN recovery procedure in response to detecting one or more errors (e.g., uncorrectable errors) at a block 170 of the memory system 110 (e.g., of a memory device 130 of the memory system 110). The RAIN recovery procedure may be used with RAIN protection, where the memory system 110 may protect data by storing (e.g., striping) redundant parity information for the data across multiple locations of the memory system 110. The set of location storing the redundant parity information may be referred to as a RAIN stripe. In some examples, the RAIN stripe may correspond to a set of blocks 170 (e.g., 64 blocks 170), and each block 170 of the set of blocks 170 may correspond to a different memory device 130 of the memory system 110. As such, if a portion of the data is lost or corrupted, the parity data corresponding to the data may be generated based on the redundant parity information, which may be used to recover the data. RAIN (Redundant Array of Independent Nodes) protection for memory systems may refer to data storage and protection techniques that distribute data across multiple locations on an array of independent nodes. In the context of memory systems, RAIN protection can help to prevent data loss and improve system performance. If one node fails, the data can still be accessed from other nodes. Such redundancy may ensure that the memory system can continue to function even in the event of a hardware failure or other type of failure.

At 210, the memory system 110 may initiate a first counter corresponding to a quantity of codewords having a high bit error count (e.g., a highBecCwCount counter). For example, the first counter may be initiated to a value of zero.

At 215, the memory system 110 may perform recovery reads for locations storing the redundant parity data. For example, the memory system 110 may begin performing read operations for locations of one or more memory devices 130 corresponding to a RAIN stripe. The memory system 110 may decode one or more codewords based on reading the locations corresponding to the RAIN stripe. As such, the operations at 220, 225, and 230 may be performed for each codeword corresponding to the RAIN stripe.

At 220, the memory system 110 may perform decoding for a codeword based on the read operations. The memory system 110 may determine a bit error count based on the decoding. For example, the memory system 110 may maintain a second counter that stores a quantity of bit errors that are detected while decoding a codeword. If the second counter satisfies (e.g., exceeds and/or meets) a threshold quantity of bit errors (e.g., a high bit error count threshold), at 225, the memory system 110 may increment the first counter corresponding to the quantity of codewords having a bit error count. If the second counter does not satisfy the threshold quantity of bit errors, the memory system 110 may refrain from increment the first counter. In some examples, if decoding is unsuccessful for a codeword (e.g., due to a large quantity of errors), the memory system 110 may increment the first counter at 225.

At 230, the memory system 110 may continue performing decoding for a next codeword. For example, the memory system 110 may continue to count a quantity of bit errors for each codeword, and increment the first counter for each codeword that satisfies the threshold quantity of bit errors, or for each codeword for which decoding does not succeed.

At 235, the memory system 110 may determine whether the first counter satisfies (e.g., exceeds and/or meets) a threshold quantity of code words having a high bit error count. The first counter satisfying the threshold quantity of code words may indicate that the memory system 110 may be experiencing intrinsic stress (e.g., due to conditions of the memory system 110, such temperature changes, power changes), for example, throughout multiple memory devices 130. This may indicate that the error that triggered the RAIN recovery procedure may be due to the conditions experienced by the memory system 110, rather than a block 170 of the memory system 110 being faulty or defected. The first counter not satisfying the threshold quantity of code word may indicate that the error conditions are localized to the block 170 associated with the error that triggered the RAIN recovery procedure. As such, this may indicate that the block may have a defect or be otherwise faulty for operation.

Accordingly, if the first counter satisfies the threshold quantity of code words, at 240, the memory system 110 may refrain from retiring the block 170 associated with triggering of the recovery procedure. Alternatively, if the first counter does not satisfy the threshold quantity of code words, at 245, the memory system 110 may retire the block 170.

By implementing these techniques, the memory system 110 may avoid preemptively retiring a block 170 if an error that triggered the recovery procedure was due to conditions experienced by the memory system 110, for example. Additionally, or alternatively, the memory system 110 may support more flexible control to classify defects in blocks 170, as the threshold quantity of codewords and the threshold quantity of bit errors may be modified (e.g., by the memory system 110 or by a host system 105) to fine tune the classification of defects (e.g., to retire blocks more or less aggressively).

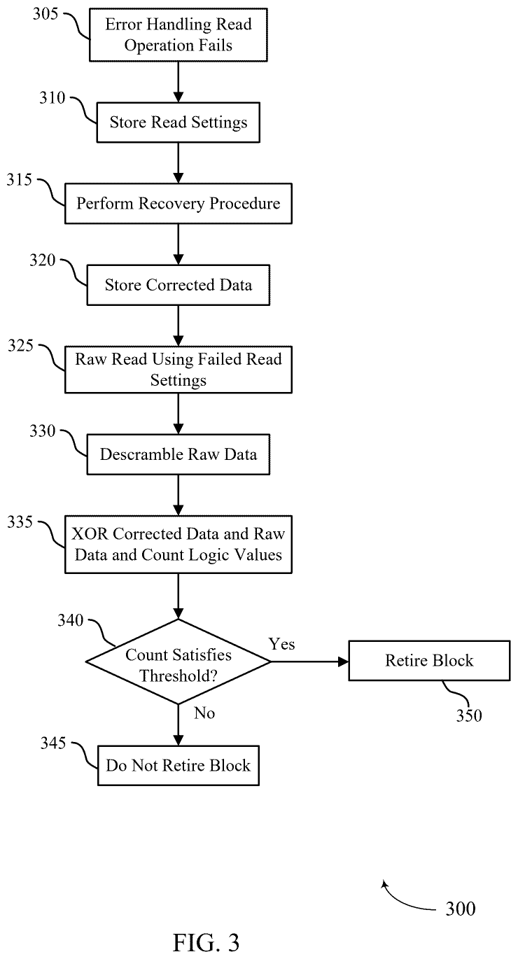

FIG. 3 shows an example of a flowchart 300 that supports handling of block retirement in accordance with examples as disclosed herein. Operations of the flowchart 300 may be implemented by a memory system 110 (e.g., a memory system controller 115, one or more local controllers 135, or a combination thereof). In some cases, the flowchart 300 may include additional operations (not shown), or operations may be omitted, modified, or performed in a different order in accordance with the described techniques.

At 305, the memory system 110 may determine that a read operation as part of an error handling procedure failed. For example, the memory system 110 may perform one or more error handling procedures based on detecting an error at a block 170 of the memory system 110. In some examples, the one or more error handling procedures may be performed prior to a RAIN recovery procedure. The read operation may correspond to a last error handling procedure performed prior to initiating the RAIN recovery procedure (e.g., or another recovery procedure).

At 310, the memory system 110 may store an indication of read settings used for performing the failed read operation. In some examples, the read settings may include read offsets, one or more temperatures associated with the read operation (e.g., including a temperature for freeze), a read mode, a decode mode, or a combination thereof.

At 315, the memory system 110 may perform the RAIN recovery procedure (e.g., or another recovery procedure) to recover data associated with the failed read operation. At 320, the memory system 110 may store the corrected data based on the RAIN recovery procedure succeeding. The stored corrected data may be user data (e.g., the user data portion of the corrected data), and the corrected data may be descrambled (e.g., as a product of the RAIN recovery procedure).

At 325, the memory system 110 may perform a read operation on raw data corresponding to the corrected data using the stored read settings for the failed read operation. For example, the memory system 110 may read the stored indication of the read settings for the failed operation. The memory system 110 may then perform a read operation on the raw data corresponding to the corrected data. For example, the memory system 110 may read the raw data as stored in the block 170 (e.g., prior to correction).

In some examples, at 330, the memory system 110 may descramble the raw data read using the stored read settings. For example, in some cases, the memory system 110 may scramble data prior to writing the data and encoding the parity information. As such, the raw data read using the stored read settings may be descrambled to facilitate comparing the read raw data with the corrected data.

At 335, the memory system 110 may compare the corrected data and the raw data. For example, the memory system 110 may perform an exclusive OR operation (e.g., an XOR operation) to compare the bits of the corrected data and the raw data. The XOR operation may output a set of bits, where a first logic value (e.g., a value of 1) for a bit represents a difference at a respective bit between the corrected data and the raw data. In some examples, the memory system 110 may count the quantity of bits having the first logic value (e.g., the value of 1) output by the XOR operation.

In some examples, a high quantity of bits having the first logic value may indicate a large difference between the corrected data and the raw data, which may indicate that the raw data contains a large quantity of errors (e.g., bit errors). The raw data containing a large quantity of errors (e.g., greater than a 20% bit error count) may indicate that the block 170 is faulty (e.g., has defects), as errors associated with intrinsic stress of the memory system 110 (e.g., conditions of the memory system 110) may be associated with a lower quantity of errors (e.g., around a 2% bit error count).

As such, at 340, the memory system 110 may determine whether the quantity of bits having the first logic value (e.g., the value of 1) satisfies (e.g., exceeds and/or meets) a threshold value. If the quantity of bits having the first logic value does not satisfy the threshold, at 345, the memory system 110 may refrain from retiring the block 170, as the corrected error may have been cause by intrinsic stress experienced by the memory system 110, for example. Alternatively, if the memory system 110 determines that the quantity of bits having the first logic value satisfies the threshold, at 350, the memory system 110 may retire the block 170. In some cases, the threshold may be modified by the memory system 110, a host system 105, or both, which may adjust the rate at which blocks 170 are retired.

By implementing these techniques, the memory system 110 may avoid preemptively retiring a block 170 if an error that triggered the recovery procedure was due to conditions experienced by the memory system 110, for example. Additionally, or alternatively, the memory system 110 may support system correction capabilities allowing for the repair or correction of a block 170 experiencing errors, while avoid the retirement of the block 170.

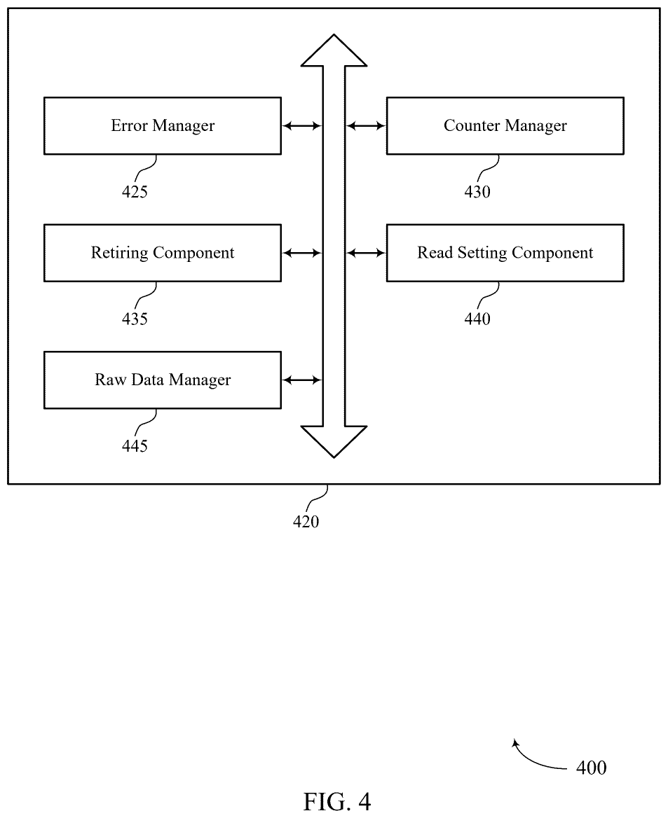

FIG. 4 shows a block diagram 400 of a memory system 420 that supports handling of block retirement in accordance with examples as disclosed herein. The memory system 420 may be an example of aspects of a memory system as described with reference to FIGS. 1 through 3. The memory system 420, or various components thereof, may be an example of means for performing various aspects of RAIN block retirement handling as described herein. For example, the memory system 420 may include an error manager 425, a counter manager 430, a retiring component 435, a read setting component 440, a raw data manager 445, or any combination thereof. Each of these components, or components of subcomponents thereof (e.g., one or more processors, one or more memories), may communicate, directly or indirectly, with one another (e.g., via one or more buses).

The error manager 425 may be configured as or otherwise support a means for reading a plurality of codewords associated with a plurality of blocks as part of a RAIN recovery procedure to determine a quantity of bit errors associated with each respective codeword of the plurality of codewords, where the RAIN recovery procedure is based at least in part on detecting an error within a first block of the plurality of blocks. The counter manager 430 may be configured as or otherwise support a means for adjusting, based at least in part on reading the plurality of codewords, a value of a counter for each respective codeword of the plurality of codewords that is associated with a quantity of bit errors that exceeds a first threshold value. The retiring component 435 may be configured as or otherwise support a means for determining whether to retire the first block from storing data for the memory system based at least in part on the value of the counter.

In some examples, the retiring component 435 may be configured as or otherwise support a means for retiring the first block from storing data based at least in part on the value of the counter failing to exceed a second threshold value. In some examples, the retiring component 435 may be configured as or otherwise support a means for refraining from retiring the first block from storing data based at least in part on the value of the counter exceeding a second threshold value.

In some examples, the counter manager 430 may be configured as or otherwise support a means for adjusting the value of the counter based at least in part on a first quantity of bit errors corresponding to a first codeword of the plurality of codewords exceeding the first threshold value. In some examples, the counter manager 430 may be configured as or otherwise support a means for refraining from adjusting the value of the counter based at least in part on a second quantity of bit errors corresponding to a second codeword of the plurality of codewords failing to exceed the first threshold value.

In some examples, the counter manager 430 may be configured as or otherwise support a means for receiving a command to adjust the value of the first threshold value, where determining whether to retire the first block is based on adjusting the value of the first threshold value. In some examples, the counter manager 430 may be configured as or otherwise support a means for adjusting the value of the counter based at least in part on a decoding operation for a first codeword of the plurality of codewords being unsuccessful.

The read setting component 440 may be configured as or otherwise support a means for storing a set of read settings associated with a failed read operation for first data stored at a first block of the memory system. The raw data manager 445 may be configured as or otherwise support a means for comparing corrected data with raw data corresponding to the failed read operation based at least in part on storing the set of read settings. In some examples, the retiring component 435 may be configured as or otherwise support a means for determining whether to retire the first block from storing data for the memory system based at least in part on comparing the corrected data with the raw data.

In some examples, to support comparing the corrected data with the raw data, the raw data manager 445 may be configured as or otherwise support a means for performing an exclusive OR operation on the corrected data and the raw data. In some examples, to support comparing the corrected data with the raw data, the raw data manager 445 may be configured as or otherwise support a means for counting a quantity of bits of an output of the exclusive OR operation having a first logic value, where determining whether to retire the first block is based at least in part on the quantity of bits having the first logic value.

In some examples, the retiring component 435 may be configured as or otherwise support a means for retiring the first block from storing data based at least in part on the quantity of bits having the first logic value satisfying (e.g., exceeding and/or meeting) a threshold value. In some examples, the retiring component 435 may be configured as or otherwise support a means for refraining from retiring the first block from storing data based at least in part on the quantity of bits having the first logic value failing to satisfy a threshold value.

In some examples, the raw data manager 445 may be configured as or otherwise support a means for reading the raw data using the stored set of read settings, where comparing the corrected data with the raw data is based at least in part on reading the raw data using the stored set of read settings. In some examples, the set of read settings includes one or more read offsets, a freeze temperature, a read mode, a decode mode, or any combination thereof.

In some examples, the raw data manager 445 may be configured as or otherwise support a means for descrambling the raw data, where comparing the corrected data with the raw data is based at least in part on descrambling the raw data.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

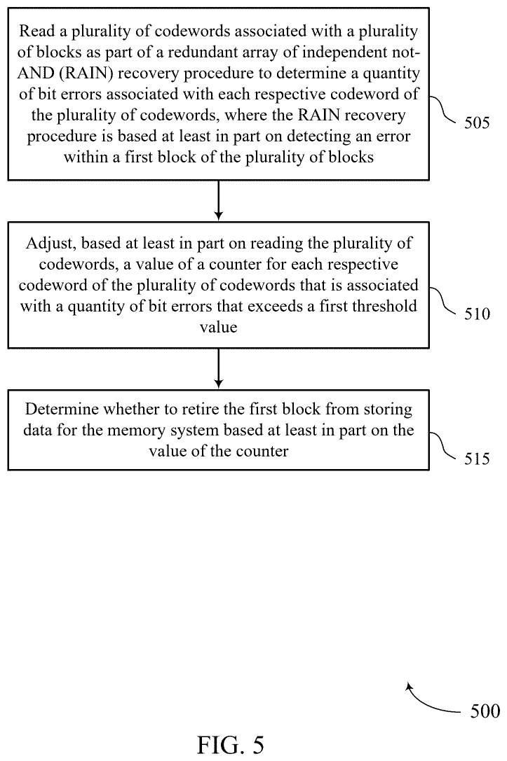

FIG. 5 shows a flowchart illustrating a method 500 that supports handling of block retirement in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include reading a plurality of codewords associated with a plurality of blocks as part of a RAIN recovery procedure to determine a quantity of bit errors associated with each respective codeword of the plurality of codewords, where the RAIN recovery procedure is based at least in part on detecting an error within a first block of the plurality of blocks. In some examples, aspects of the operations of 505 may be performed by an error manager 425 as described with reference to FIG. 4.

At 510, the method may include adjusting, based at least in part on reading the plurality of codewords, a value of a counter for each respective codeword of the plurality of codewords that is associated with a quantity of bit errors that exceeds a first threshold value. In some examples, aspects of the operations of 510 may be performed by a counter manager 430 as described with reference to FIG. 4.

At 515, the method may include determining whether to retire the first block from storing data for the memory system based at least in part on the value of the counter. In some examples, aspects of the operations of 515 may be performed by a retiring component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for reading a plurality of codewords associated with a plurality of blocks as part of a RAIN recovery procedure to determine a quantity of bit errors associated with each respective codeword of the plurality of codewords, where the RAIN recovery procedure is based at least in part on detecting an error within a first block of the plurality of blocks; adjusting, based at least in part on reading the plurality of codewords, a value of a counter for each respective codeword of the plurality of codewords that is associated with a quantity of bit errors that exceeds a first threshold value; and determining whether to retire the first block from storing data for the memory system based at least in part on the value of the counter.

Aspect 2: The method, apparatus, or non-transitory computer-readable medium of aspect 1, further including operations, features, circuitry, logic, means, or instructions, or any combination thereof for retiring the first block from storing data based at least in part on the value of the counter failing to exceed a second threshold value.

Aspect 3: The method, apparatus, or non-transitory computer-readable medium of any of aspects 1 through 2, further including operations, features, circuitry, logic, means, or instructions, or any combination thereof for refraining from retiring the first block from storing data based at least in part on the value of the counter exceeding a second threshold value.

Aspect 4: The method, apparatus, or non-transitory computer-readable medium of any of aspects 1 through 3, further including operations, features, circuitry, logic, means, or instructions, or any combination thereof for adjusting the value of the counter based at least in part on a first quantity of bit errors corresponding to a first codeword of the plurality of codewords exceeding the first threshold value.

Aspect 5: The method, apparatus, or non-transitory computer-readable medium of any of aspects 1 through 4, further including operations, features, circuitry, logic, means, or instructions, or any combination thereof for refraining from adjusting the value of the counter based at least in part on a second quantity of bit errors corresponding to a second codeword of the plurality of codewords failing to exceed the first threshold value.

Aspect 6: The method, apparatus, or non-transitory computer-readable medium of any of aspects 1 through 5, further including operations, features, circuitry, logic, means, or instructions, or any combination thereof for adjusting the value of the counter based at least in part on a decoding operation for a first codeword of the plurality of codewords being unsuccessful.

Aspect 7: The method, apparatus, or non-transitory computer-readable medium of any of aspects 1 through 5, further including operations, features, circuitry, logic, means, or instructions, or any combination thereof for receiving a command to adjust the first threshold value, where determining whether to retire the first block is based at least in part on adjusting the value of the first threshold value.

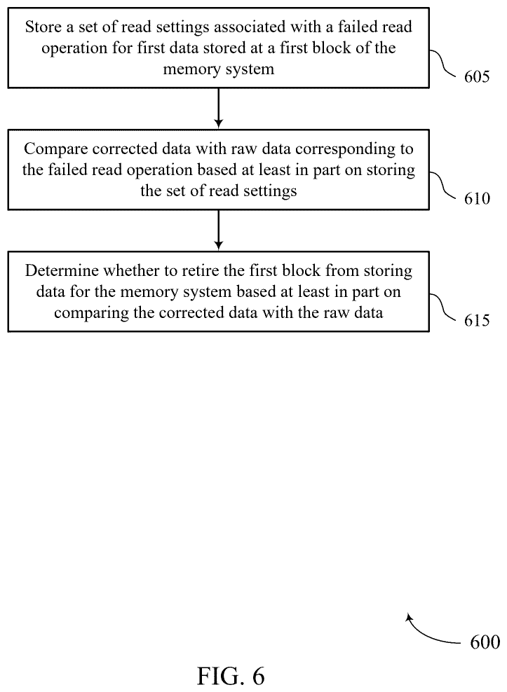

FIG. 6 shows a flowchart illustrating a method 600 that supports handling of block retirement in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include storing a set of read settings associated with a failed read operation for first data stored at a first block of the memory system. In some examples, aspects of the operations of 605 may be performed by a read setting component 440 as described with reference to FIG. 4.

At 610, the method may include comparing corrected data with raw data corresponding to the failed read operation based at least in part on storing the set of read settings. In some examples, aspects of the operations of 610 may be performed by a raw data manager 445 as described with reference to FIG. 4.

At 615, the method may include determining whether to retire the first block from storing data for the memory system based at least in part on comparing the corrected data with the raw data. In some examples, aspects of the operations of 615 may be performed by a retiring component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 8: A method, apparatus, or non-transitory computer-readable medium including operations, features, circuitry, logic, means, or instructions, or any combination thereof for storing a set of read settings associated with a failed read operation for first data stored at a first block of the memory system; comparing corrected data with raw data corresponding to the failed read operation based at least in part on storing the set of read settings; and determining whether to retire the first block from storing data for the memory system based at least in part on comparing the corrected data with the raw data.

Aspect 9: The method, apparatus, or non-transitory computer-readable medium of aspect 8, where comparing the corrected data with the raw data further includes operations, features, circuitry, logic, means, or instructions, or any combination thereof for performing an exclusive OR operation on the corrected data and the raw data and counting a quantity of bits of an output of the exclusive OR operation having a first logic value, where determining whether to retire the first block is based at least in part on the quantity of bits having the first logic value.

Aspect 10: The method, apparatus, or non-transitory computer-readable medium of aspect 9, further including operations, features, circuitry, logic, means, or instructions, or any combination thereof for retiring the first block from storing data based at least in part on the quantity of bits having the first logic value satisfying (e.g., meeting and/or exceeding) a threshold value.

Aspect 11: The method, apparatus, or non-transitory computer-readable medium of any of aspects 9 through 10, further including operations, features, circuitry, logic, means, or instructions, or any combination thereof for refraining from retiring the first block from storing data based at least in part on the quantity of bits having the first logic value failing to satisfy a threshold value.

Aspect 12: The method, apparatus, or non-transitory computer-readable medium of any of aspects 8 through 11, further including operations, features, circuitry, logic, means, or instructions, or any combination thereof for reading the raw data using the stored set of read settings, where comparing the corrected data with the raw data is based at least in part on reading the raw data using the stored set of read settings.

Aspect 13: The method, apparatus, or non-transitory computer-readable medium of aspect 12, where the set of read settings includes one or more read offsets, a freeze temperature, a read mode, a decode mode, or any combination thereof.

Aspect 14: The method, apparatus, or non-transitory computer-readable medium of any of aspects 8 through 13, further including operations, features, circuitry, logic, means, or instructions, or any combination thereof for descrambling the raw data, where comparing the corrected data with the raw data is based at least in part on descrambling the raw data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
read a plurality of codewords associated with a plurality of blocks as part of a redundant array of independent not-AND (RAIN) recovery procedure to determine a quantity of bit errors associated with each respective codeword of the plurality of codewords, wherein the RAIN recovery procedure is based at least in part on detecting an error within a first block of the plurality of blocks;
adjust, based at least in part on reading the plurality of codewords, a value of a counter for each respective codeword of the plurality of codewords that is associated with a quantity of bit errors that exceeds a first threshold value; and
determine whether to retire the first block from storing data for the memory system based at least in part on the value of the counter.

2. The memory system of claim 1, wherein the processing circuitry is further configured to cause the memory system to:
retire the first block from storing data based at least in part on the value of the counter failing to exceed a second threshold value.

3. The memory system of claim 1, wherein the processing circuitry is further configured to cause the memory system to:
refrain from retiring the first block from storing data based at least in part on the value of the counter exceeding a second threshold value.

4. The memory system of claim 1, wherein the processing circuitry is further configured to cause the memory system to:
adjust the value of the counter based at least in part on a first quantity of bit errors corresponding to a first codeword of the plurality of codewords exceeding the first threshold value.

5. The memory system of claim 1, wherein the processing circuitry is further configured to cause the memory system to:
refrain from adjusting the value of the counter based at least in part on a second quantity of bit errors corresponding to a second codeword of the plurality of codewords failing to exceed the first threshold value.

6. The memory system of claim 1, wherein the processing circuitry is further configured to cause the memory system to:
adjust the value of the counter based at least in part on a decoding operation for a first codeword of the plurality of codewords being unsuccessful.

7. The memory system of claim 1, wherein the processing circuitry is further configured to cause the memory system to:
receive a command to adjust the first threshold value, wherein the determination of whether to retire the first block is based at least in part on the adjustment of the first threshold value.

8. A memory system, comprising:
one or more memory devices; and
processing circuitry coupled with the one or more memory devices and configured to cause the memory system to:
store a set of read settings associated with a failed read operation for first data stored at a first block of the memory system;
compare corrected data with raw data corresponding to the failed read operation based at least in part on storing the set of read settings; and
determine whether to retire the first block from storing data for the memory system based at least in part on comparing the corrected data with the raw data.

9. The memory system of claim 8, wherein comparing the corrected data with the raw data further comprises the processing circuitry configured to cause the memory system to:
perform an exclusive OR operation on the corrected data and the raw data; and
count a quantity of bits of an output of the exclusive OR operation having a first logic value, wherein determining whether to retire the first block is based at least in part on the quantity of bits having the first logic value.

10. The memory system of claim 9, wherein the processing circuitry is further configured to cause the memory system to:
retire the first block from storing data based at least in part on the quantity of bits having the first logic value satisfying a threshold value.

11. The memory system of claim 9, wherein the processing circuitry is further configured to cause the memory system to:
refrain from retiring the first block from storing data based at least in part on the quantity of bits having the first logic value failing to satisfy a threshold value.

12. The memory system of claim 8, wherein the processing circuitry is further configured to cause the memory system to:
read the raw data using the stored set of read settings, wherein comparing the corrected data with the raw data is based at least in part on reading the raw data using the stored set of read settings.

13. The memory system of claim 12, wherein the set of read settings comprises one or more read offsets, a freeze temperature, a read mode, a decode mode, or any combination thereof.

14. The memory system of claim 8, wherein the processing circuitry is further configured to cause the memory system to:
descramble the raw data, wherein comparing the corrected data with the raw data is based at least in part on descrambling the raw data.

15. A method by a memory system, comprising:
reading a plurality of codewords associated with a plurality of blocks as part of a redundant array of independent not-AND (RAIN) recovery procedure to determine a quantity of bit errors associated with each respective codeword of the plurality of codewords, wherein the RAIN recovery procedure is based at least in part on detecting an error within a first block of the plurality of blocks;
adjusting, based at least in part on reading the plurality of codewords, a value of a counter for each respective codeword of the plurality of codewords that is associated with a quantity of bit errors that exceeds a first threshold value; and
determining whether to retire the first block from storing data for the memory system based at least in part on the value of the counter.

16. The method of claim 15, further comprising:
retiring the first block from storing data based at least in part on the value of the counter failing to exceed a second threshold value.

17. The method of claim 15, further comprising:
refraining from retiring the first block from storing data based at least in part on the value of the counter exceeding a second threshold value.

18. The method of claim 15, further comprising:
adjusting the value of the counter based at least in part on a first quantity of bit errors corresponding to a first codeword of the plurality of codewords exceeding the first threshold value.

19. The method of claim 15, further comprising:
refraining from adjusting the value of the counter based at least in part on a second quantity of bit errors corresponding to a second codeword of the plurality of codewords failing to exceed the first threshold value.

20. The method of claim 15, further comprising:
adjusting the value of the counter based at least in part on a decoding operation for a first codeword of the plurality of codewords being unsuccessful.

21. A method by a memory system, comprising:
storing a set of read settings associated with a failed read operation for first data stored at a first block of the memory system;
comparing corrected data with raw data corresponding to the failed read operation based at least in part on storing the set of read settings; and
determining whether to retire the first block from storing data for the memory system based at least in part on comparing the corrected data with the raw data.

22. The method of claim 21, wherein comparing the corrected data with the raw data further comprises:
performing an exclusive OR operation on the corrected data and the raw data; and
counting a quantity of bits of an output of the exclusive OR operation having a first logic value, wherein determining whether to retire the first block is based at least in part on the quantity of bits having the first logic value.

23. The method of claim 22, further comprising:
retiring the first block from storing data based at least in part on the quantity of bits having the first logic value satisfying a threshold value.

24. The method of any of claims 22 through 23, further comprising:
refraining from retiring the first block from storing data based at least in part on the quantity of bits having the first logic value failing to satisfy a threshold value.

25. The method of any of claims 21 through 24, further comprising:
reading the raw data using the stored set of read settings, wherein comparing the corrected data with the raw data is based at least in part on reading the raw data using the stored set of read settings.

26. The method of claim 25, wherein the set of read settings comprises one or more read offsets, a freeze temperature, a read mode, a decode mode, or any combination thereof.

27. The method of any of claims 21 through 26, further comprising:
descrambling the raw data, wherein comparing the corrected data with the raw data is based at least in part on descrambling the raw data.

28. A non-transitory computer-readable medium storing code, the code comprising instructions executable by one or more processors to:
read a plurality of codewords associated with a plurality of blocks as part of a redundant array of independent not-AND (RAIN) recovery procedure to determine a quantity of bit errors associated with each respective codeword of the plurality of codewords, wherein the RAIN recovery procedure is based at least in part on detecting an error within a first block of the plurality of blocks;
adjust, based at least in part on reading the plurality of codewords, a value of a counter for each respective codeword of the plurality of codewords that is associated with a quantity of bit errors that exceeds a first threshold value; and
determine whether to retire the first block from storing data for a memory system based at least in part on the value of the counter.

29. The non-transitory computer-readable medium of claim 28, wherein the instructions are further executable by the one or more processors to:
retire the first block from storing data based at least in part on the value of the counter failing to exceed a second threshold value.

30. The non-transitory computer-readable medium of claim 28, wherein the instructions are further executable by the one or more processors to:
refrain from retiring the first block from storing data based at least in part on the value of the counter exceeding a second threshold value.
